(19) United States
(12) Patent Application Publication
(10) Pub. No.: US 2016/0088708 A1
(43) Pub. Date: Mar. 24, 2016

(54) WIRELESS CONTROL OF LIGHTING SYSTEMS

(71) Applicants: Mervyn Anthony, Woburn, MA (US); Jeremy Spaulding, Marblehead, MA (US)

(72) Inventors: Mervyn Anthony, Woburn, MA (US); Jeremy Spaulding, Marblehead, MA (US)

(73) Assignee: OSRAM SYLVANIA INC., Danvers, MA (US)

(21) Appl. No.: 14/490,124

(22) Filed: Sep. 18, 2014

(51) Int. Cl. H05B 37/02

(52) U.S. Cl. CPC H05B 37/029; H05B 37/0272; H05B 37/0281

(57) ABSTRACT

A communication protocol is disclosed to wirelessly control and configure an array of lighting fixtures. The protocol allows dynamic lighting of a group of light fixtures or a single light fixture such that the protocol can support unicasting, multicasting and broadcasting communications. This protocol enables intelligent lighting fixtures to be automatically discovered in a wireless network. The protocol may also be used to configure the network parameters automatically, and can also upgrade the firmware or other local memory of the lighting fixtures. Additionally, the protocol may be used to control a media projecting device and/or servers, to change the media contents based on a scene locally selected at the area being illuminated. The lighting and media can collectively define or otherwise provide an overall “scene” by virtue of the lighting characteristics and media playback.

### FIELD OF THE DISCLOSURE

The present application generally relates to lighting systems, and more specifically to techniques for dynamically adjusting general purpose lighting.

### BACKGROUND

The power of light to transform human perception is a powerful tool that is often exploited to maximize dramatic effect, draw contrast, and elicit emotion. Photographers, restaurateurs, and cinematographers, to name just a few, employ various light manipulation techniques to capitalize on these effects through controlling the position, amount, and dispersion of light. Often, these techniques include the use of artificial lighting. Such artificial light can be provided, for instance, through general lighting devices such as modern LED-based lamps or traditional light sources such as an incandescent bulb. However, it can be a challenge to utilize artificial light to re-create certain effects such as natural light. Likewise, some areas to be lit may require a complex mixture of natural (or ambient light) as well as subdued lighting (e.g., a simulated candle flicker).

### BRIEF DESCRIPTION OF THE DRAWINGS

FIG. 1 is a block diagram illustrating a dynamic light system including a controller and a plurality of nodes in accordance with an embodiment of the present disclosure.

FIG. 2 shows a method of dynamically discovering, configuring, and controlling nodes of a dynamic light system in accordance with an embodiment of the present disclosure.

FIG. 3 is a sequential protocol diagram showing communication between a controller and N nodes of a dynamic light system in accordance with an embodiment of the present disclosure.

FIG. 4 is an example controller configured to control a dynamic light system via a custom user interface in accordance with an embodiment of the present disclosure.

FIG. 5 illustrates a computing system configured to execute various processes for dynamically adjusting lighting in accordance with techniques and aspects provided in the present disclosure.

These and other features of the present embodiments will be understood better by reading the following detailed description, taken together with the figures herein described. The accompanying drawings are not intended to be drawn to scale. In the drawings, each identical or nearly identical component that is illustrated in various figures may be represented by a like numeral. For purposes of clarity, not every component may be labeled in every drawing.

### DETAILED DESCRIPTION

A communication protocol is disclosed to control and configure a large array of lighting fixtures wirelessly in a reliable synchronous fashion. This protocol allows dynamic lighting of a group of light fixtures or a single light fixture such that the protocol can support unicasting, multicasting and broadcasting communications. This protocol enables intelligent lighting fixtures to be automatically discovered in a wireless network. In an embodiment, the protocol can support multiple channels per lighting fixture, and can also handle the CIE XYZ color model to re-optimize and reproduce color based on the color gamut of the fixture. The protocol may also be used to configure the network parameters automatically, and can also upgrade the firmware or other local memory of the lighting fixtures. Additionally, the protocol may be used to control a media projecting device and/or servers (if available), to change the media contents based on a scene locally selected at the area being illuminated. The lighting and media can collectively define or otherwise provide an overall “scene” by virtue of the lighting characteristics and media playback.

General Overview

As previously explained, it can be a challenge to utilize artificial light to re-create certain effects such as natural light and to provide a suitable lighting scheme to a given area. For this reason, there is generally no “one size fits all” approach to lighting a scene and instead each scene requires careful selection, placement, and filtering of light sources to achieve a desired effect. In addition, to control a group of LED fixtures discretely or synchronously, a human operator or a physical device like a switch or handheld device typically has to compromise over the latency and/or reliability of the communication process. For instance, to create an automated light sequence without a given protocol, multiple packets would have to be sent sequentially, each holding the information of a particular light pattern. Likewise, in order to upgrade the firmware of a given LED fixture, the firmware (memory chip) typically has to be physically removed/disconnected from its location and then programmed or flashed using a programming device.

Thus, and in accordance with an embodiment of the present disclosure, a communication protocol is disclosed to control and configure a large array of lighting fixtures wirelessly in a reliable synchronous fashion. The protocol allows dynamic lighting of a group of light fixtures or a single light fixture such that the protocol can support unicasting, multicasting and broadcasting communications. The protocol enables lighting fixtures (such as LED fixtures or any other lighting fixtures having some degree of local intelligence) to be automatically discovered in a network. In an embodiment, the protocol is based on the TCP/IP protocol and can support multiple LED fixtures each having multiple channels (e.g., up to 15 channels each). The protocol can also handle the CIE XYZ color model to re-optimize and reproduce color based on the color gamut of the fixture. The protocol may also be used to configure typical network parameters automatically, and can also be used to upgrade the firmware or other local memory of the lighting fixtures.

Additionally, the protocol may be used to control a media projecting device and/or servers (if available), to change the media contents based on a scene locally selected at the area being illuminated. To this end, the lighting and media can collectively define or otherwise provide an overall “scene” by virtue of the lighting characteristics and media playback, which may include for example, a digital picture slide show or other imagery, video, and/or music or other audio (e.g., oceans sounds, office sounds, night club sounds, etc). In some such embodiments, a lighting system executing the protocol can be configured to dynamically illuminate an area based on a predefined virtual environment. The predefined virtual environment can be, for example, user-selected or randomly selected from a set of virtual environments, or auto-selected based observations made by the system (by virtue of sensors such as microphones and cameras operatively coupled to voice/sound analysis and image analysis modules, respectively.

In one example case, the lighting system includes a one or more nodes including one or more light assemblies and media devices that are communicatively coupled to a wireless communication network. A controller also communicatively coupled to that network is configured to discover and configure the various lighting and media devices on the network, and to effectively control the scene(s) provided by the nodes. In some cases, the system further includes a user interface (UI) that allows a user to interact with the controller and control the scene selection process. In one example embodiment, the UI is touchscreen-based and can be implemented on any suitable computing system, such as a computer system deployed in a kiosk or workstation-like area, or a wireless computing device such as a tablet or smartphone. In any such cases, the UI provides an intuitive user interface and communicatively couples that computing system to the controller, which in turn wirelessly controls the lighting and media to provision a selected scene. In some embodiments, the computing system on which the UI is executing includes the controller. In other embodiments, the controller may be a separate computing system, and the UI computing system can be communicatively coupled to the controller by a wired or wireless connection, as will be appreciated. The scene control data provided by the controller can then be wirelessly communicated to the various lighting/media nodes on the wireless network. As used herein, scene control data generally refers to a set of predefined values, that when executed by the one or more nodes, can cause a particular virtual environment to be illuminated or otherwise presented within an area. In some cases, the predefined values include, for example, timing information, color stimulus values and media file information. As will be appreciated in light of this disclosure, the scene control data can be translated into or otherwise include instructions that cause the lighting system to generate the target scene or virtual environment.

Once a scene has been selected via the UI, and in accordance with an embodiment, each node receives instructions or other data from the controller based on scene control data corresponding to the selected scene to recreate a virtual environment associated with that selected scene. As will be appreciated in light of this disclosure, the scene control data may include illumination and/or media playback data. For instance, in some cases, illumination data associated with the scene may include instructions or control signals to cause various light qualities based on predefined characteristics (e.g., intensity, color) and time intervals to output specific light patterns. Alternatively, or in addition to, media data associated with the scene may include still images and/or movies that can be projected or otherwise displayed, as well as audio file playback that can be aurally presented, via a given node. In other cases, media data associated with the scene may include the memory location of still images, movies, and/or audio files selected for playback via a given node, such that the target media content can be accessed when needed. In any such cases, the scene control data can be executed to effectively cause each node to recreate the selected virtual environment or a portion of that environment, as the case may be. Communication over the network between the controller and the plurality of nodes is wirelessly implemented, for example, using TCP/IP protocols and one or more wireless access points.

In an embodiment, the controller includes or is otherwise communicatively coupled with an application that is executable on a mobile computing device (e.g., tablet, laptop, or smartphone) and is configured to store a number of predefined virtual environments in the form of scene control data in a memory of the mobile computing device. In some cases, the scene control data for one or more distinct virtual environments may be received from a web service (local, or via a wide-area network) or so-called “app store” which provides a number of virtual environments available for download. Alternatively, or in addition to, the scene control data for at least some of the available virtual environments may be derived or otherwise based on user input or user-defined scenes. As will be appreciated in light of this disclosure, such user-generated scene control data can be uploaded to a remote app store or other depository so that it can be downloaded and used by others having a similarly configured lighting system, if so desired, perhaps for a fee in some instances.

In accordance with an embodiment, the controller is configured to, by virtue of the communication protocol, wirelessly discover each lighting and media device that is communicatively coupled to the wireless network. For example, each lighting and media device can be configured with a service set identifier (SSID) and authentication key corresponding to a particular wireless access point which facilitates network communication between those devices and the controller, using a TCP/IP protocol suite. In this example, the various lighting and media devices making up the nodes on the wireless network are configured to receive and process TCP/IP messages so as to allow for their discoverability, management, and operational (scene) control by the controller. As will be appreciated in light of this disclosure, discovery may include not only identification of a node device and an associated address (e.g., IPv4/IPv6), but also, for example, node type (e.g., lighting node, media node, or hybrid node including both lighting and media), lighting and/or projection capabilities (e.g., light color(s), light intensity range, display resolution, display refresh rate, decibel range, and media type playback capability such as MPEG, JPEG, or MP3), and associated firmware information (e.g., revision, size, and hash for tamper-proofing).

Once discovery is complete, the controller may then perform various management functions on the discovered nodes. Management functions may include, for example, setting at least one programmable parameter such as a group identifier (GID), a unique identifier (UID), a unique lighting system identifier (USID), a SSID and a passphrase. Other management functions will be apparent in light of this disclosure. For instance, management functions may include performing a remote upgrade of a device's firmware. In each of these examples, the controller may automatically perform these management functions upon discovery of a node, or based on defined schedule, or based on user input.

During scene control, and in accordance with an embodiment, the controller wirelessly unicasts or broadcasts messages including a payload of scene control data to each node which, in turn, causes the corresponding lighting/media device(s) to perform illumination and/or presentation of media (image and/or audio based content) in accordance with the scene control data. As previously explained, scene control data may include a list of scene instructions that cause a predefined sequence of light and media output. For example, the instructions can include dynamic light patterns (or effects) which, when executed by the node, cause the light assembly to emit various light characteristics for predefined time intervals. In some embodiments, the light characteristics may include CIE XYZ tri-stimulus values defined within the scene instructions which a node may interpret and optimize based on its color gamut (or color output capability). In other embodiments, the scene instructions may direct color channel output explicitly for a node by, for example, providing RGB and RGBY values. It will be appreciated that numerous other color models may be utilized in various aspects and embodiments disclosed herein. So, certain aspects of scene control data or instructions disclosed herein comprise a flexible means by which a node can be wirelessly controlled to output a dynamic pattern of light. These dynamic light patterns might form recognizable or theme-based or otherwise desirable light patterns when executed by the node. Some example light patterns include flickering of candle light, strobe lighting effect, day lighting, night club mode, office mode, and beach mode, to name a few. Numerous theme-based lighting effects can be provided, as will be appreciated in light of this disclosure.

Scene instructions may also include one or more media files to render (e.g., .wav, .mp3, .mpeg, .mov, etc), or an indication of where a target media file is located so that it can be accessed by the node for playback. In any such cases, a node configured with a media playback device may then render the media files in an order and duration as defined by the scene instructions. In some cases, scene instructions may be unique to each node, or unique to a group of two or more nodes. In either case, once a node receives scene instructions, the node can discard any previously received scene instructions and initiate illumination and/or media playback based on the new scene instructions. To this end, scene instructions can encapsulate all instructions necessary for a node to indefinitely illuminate and/or present content until the controller interrupts through a subsequent scene change or a shutdown request. The aggregate effect of each node illuminating and/or presenting media in accordance with their respective scene instructions can result in a fully immersive virtual environment being recreated within a given area of the lighting system.

It should be appreciated that numerous applications are within the scope such a lighting system and can include, for instance, dressing rooms in retail clothing stores, night clubs, trade show booths, bowling halls, or virtually physical space that selective illumination of a virtual environment is desired.

Dynamic Light System Architecture

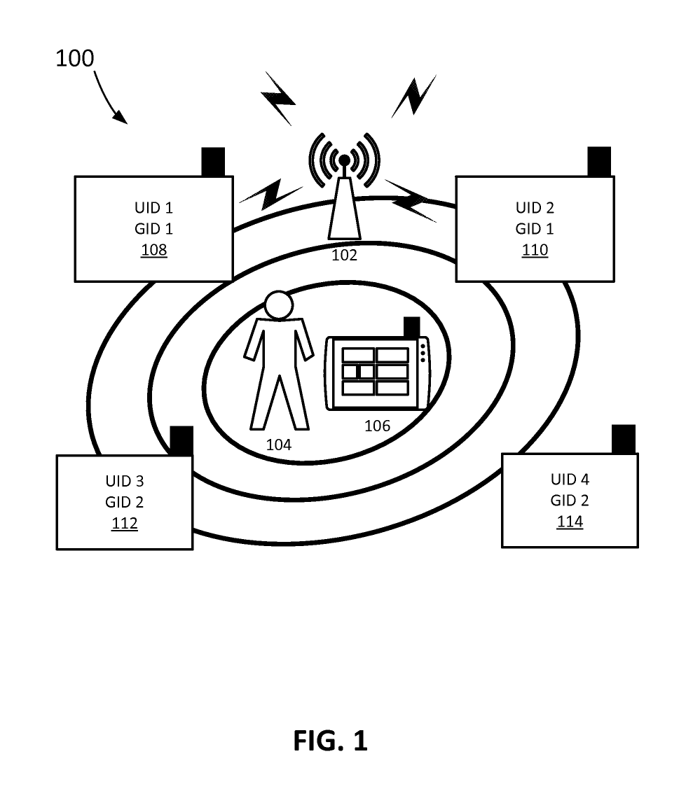

An example embodiment disclosed herein includes a dynamic light system that is capable of discovering, configuring, and controlling a number of nodes to illuminate an area according to a predetermined virtual environment. FIG. 1 is a block diagram illustrating one such example dynamic light system 100 in accordance with an embodiment of the present disclosure. As can be seen, the system 100 includes a controller 106 and a plurality of nodes 108, 110, 112 and 114 that are accessible to the controller 106 via a wireless access point 102. Although only four nodes are shown in FIG. 1, it will be appreciated that any number of nodes may be present (one or more nodes), depending on factors such as complexity of the system and available network bandwidth. As is further shown in this example embodiment, controller 106 is a tablet device that a user 104 can utilize to perform various functions and processes as provided herein.

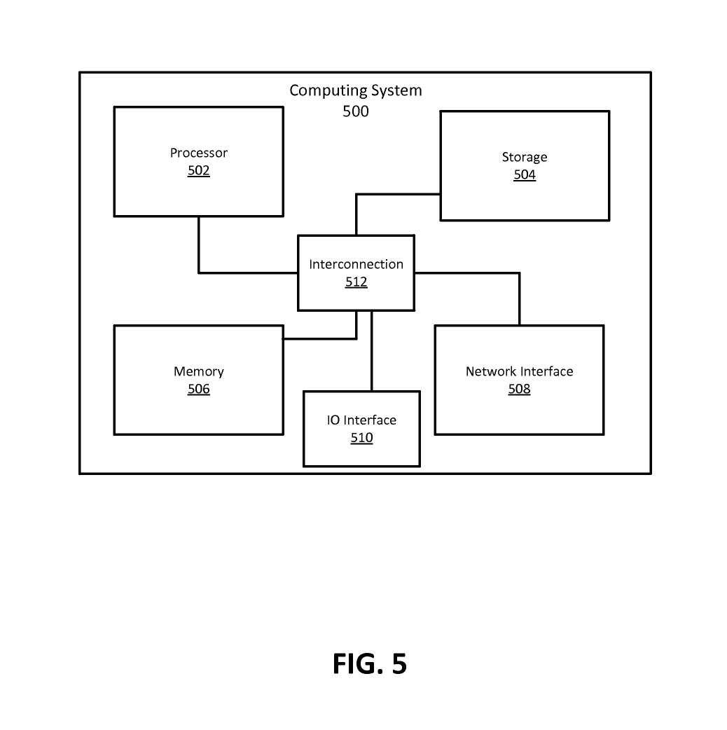

A specific example embodiment of controller 106 is the computing device 500 of FIG. 5, which will be discussed in turn. In some embodiments, the controller 106 is a touchscreen device, and may execute an application which is configured to receive user input and wirelessly communicate with the wireless access point 102 via an antenna. In this embodiment, the controller 106 may be configured with or otherwise configured to operate in conjunction with user interface screens that enable the user 104 to select scenes and to effectively control of nodes 108-114, and to the extent not automatically performed by the protocol, to execute discovery and configuration of nodes 108-114. In one specific embodiment, communication between the controller 106 and the nodes 108-114 is carried out in accordance with the IEEE 802.11 protocol, sometimes referred to as Wi-Fi. However, other suitable wireless communication protocols that are capable of wirelessly discovering nodes 108-114 and delivering payload including scene control data or scene instructions to those nodes will be apparent in light of this disclosure. Other example wireless protocols include Bluetooth and ZigBee.

In an embodiment, each of nodes 108-114 is physically positioned within an area (such as a room, hall, etc.) to provide illumination and/or presentation of media. In one case, the physical position of a node is only limited by the operable range of the access point 102. Thus, a node may be disposed virtually anywhere in an area so long as the node remains within communication range of the wireless access point 102, or is connected by a fixed-wire connection to the network. In some cases, a given node may be configured with one or more light assemblies that are capable of producing light with constant or adjustable color characteristics. In these cases, the light assemblies may be configured with one or more color channels which may be utilized to execute scene instructions. For instance, nodes may be configured to produce white light with adjustable color temperature (typically measured as correlated color temperature (CCT)) through a lighting assembly utilizing phosphor conversion (PC). In this instance, a node may be configured with one color channel being a blue, or near-ultraviolet, emitting die that can be combined with additional color channels such as ones having a yellow-emitting phosphor, or any other suitable phosphor. Alternatively, a given node might be configured to use a combination of colored LEDs (e.g., red, green, and blue (RGB)) in numerous color channel configurations (e.g., each color being a distinct color channel) to produce white light with varying color temperature. To this end, a given node might be configured in numerous ways with varying numbers of color channels utilizing one or more color output techniques (mixing, down-conversion, etc.) to produce a desired output. In addition, in some embodiments, a lighting assembly may be configured with a diffuser to uniformly emit ambient light in a given area. In an embodiment, at least one of the nodes 108-114 is configured with a projection device such as a LCD flat-panel screen or any projection device capable of rendering a visual image (e.g., a projector lamp). It should be appreciated that a node may be comprised of more than one lighting assembly or projection device. For example, in some cases a given node may include multiple LED-based lighting assemblies as well as a LCD screen. In this example, a node may appear as two or more logical nodes within the context of the dynamic light system 100 in order to facilitate controlling each device within the node independently. In an embodiment, each of nodes 108-114 may comprise a computing device such as the computing device 500 of FIG. 5 or some degree of intelligence. In some example cases, each of nodes 108-114 comprises a programmable device, such as an Arduino or other single-board computer or microcontroller. Each microcontroller has similar hardware and capabilities to that of general computing devices, such as the computing device 500 of FIG. 5, but with the added customization of being specially programmed or otherwise configurable to independently (without on-going instruction from a centralized control system) perform one or more specialized automated functions on a periodic basis. In addition, lighting assemblies such as light engines and luminaires are sometimes configured with such local intelligence, as can be media devices. Thus, each node may have a programmable intelligence that can be leveraged by the communication protocol.

Still referring to FIG. 1, each of nodes 108-114 includes a UID which uniquely identifies the node within the dynamic light system 100 and a GID which associates a node to a particular group of nodes. In an embodiment, the UID may be set by the controller 106 after discovery of a node. Likewise, the controller 106 may associate two or more nodes to a group based on user input and/or one or more factors such as, for example, node type, color channel configuration, physical position identifier, and media playback capabilities. To this end, a controller 106 may unicast/broadcast/multicast protocol messages to a single node, a group of nodes, or all nodes within the light system 100 with each node being capable of receiving the message and determining the message is relevant to the node based on the logical identifiers (UID, GID, USID, etc.).

Dynamic Light System Processes

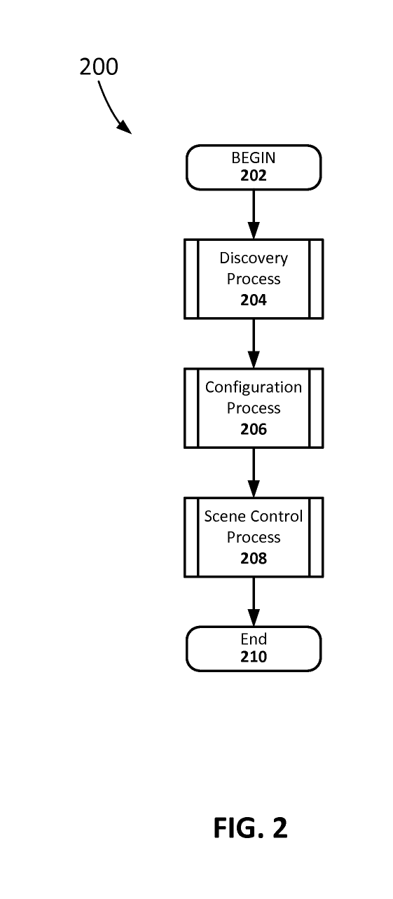

As discussed above with reference to FIG. 1, some embodiments of the present disclosure include processes directed to management and control of nodes within the dynamic light system 100. In some embodiments, these management and control processes are executed by the controller 106 of FIG. 1. FIG. 2 depicts one such example method 200 including sub-routine processes (or modes) directed to dynamically discovering, configuring, and controlling nodes of the dynamic light system 100 in accordance with an embodiment of the present disclosure. As discussed above, nodes may be configured to receive and process standardized or proprietary protocol messages from the controller 106. Although the following embodiments and examples include specific instances of a binary protocol (e.g., contiguous data structures encapsulated in UDP packets) this disclosure is not so limited. In some embodiments, the protocol may be implemented in numerous other formats including, for example, XML, JSON, etc. The method 200 beings in act 202.

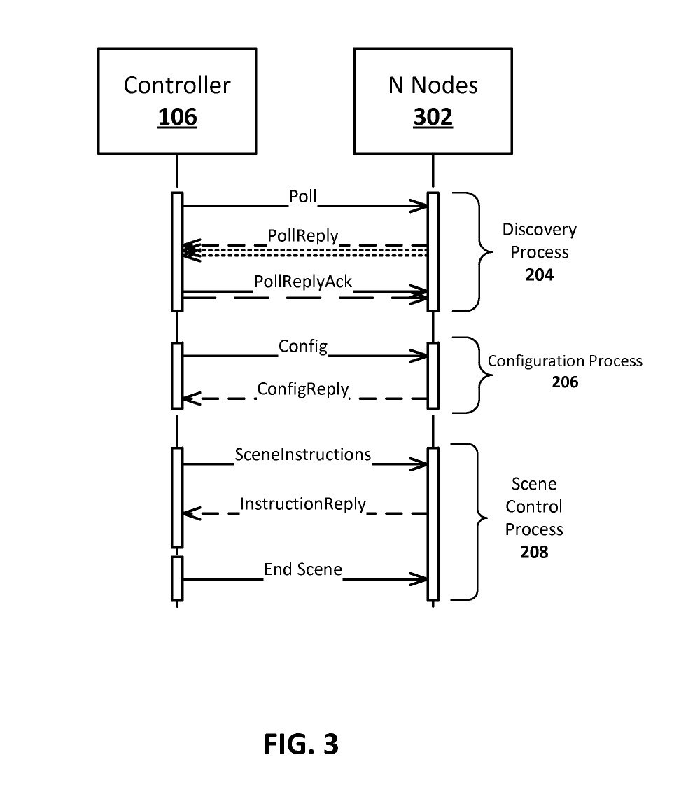

In act 204, a discovery process is executed by the controller 106. The discovery process may be executed in response to, for example, user input, or automatically when the various intelligent nodes are powered-up (e.g., using self-discovery features of a wireless protocol like Wi-Fi or Bluetooth). In an embodiment, the discovery process 204 is executed once prior to subsequent processes being executed in acts 206-208. In other embodiments, the discovery process 204 may be executed periodically in an automated or manual fashion to determine the presence of additional nodes and to assign logical identifiers accordingly. In any such embodiments, the discovery process 204 may begin by the controller 106 broadcasting one or more poll packets (or discovery packets) via the network to discover all controllers, nodes and content servers communicatively coupled to the same network. As shown in FIG. 3, an example communication sequence during the discovery process 204 is illustrated. As shown, the controller 106 asynchronously broadcasts a Poll packet to N Nodes 302. In an embodiment, the Poll packet is transmitted via a UDP broadcast message to all nodes on the network (1:N). In this embodiment, each node which receives the Poll packet replies back to the controller 106 to indicate their presence and compatibility with the controller 106. As shown, more than one node may respond to the Poll packet and this N:1 communication is illustrated with a series of dotted communication lines following the Poll packet. In response to the Poll packet, any number of nodes may respond through a PollReply packet. In some cases, the PollReply packet includes node configuration parameters such as, for example, an IP address, a listening port, a GID, a UID, a USID, a node type and a firmware version. In an embodiment, the controller 106 may store the configuration parameters received in the PollReply packet in a memory or database. In this embodiment, the controller may index the configuration parameters based on the UID of the node (or combination of parameters such as GID, USID, etc) and later retrieve the configuration parameters in subsequent processes. In some cases, the controller 106 may provide an acknowledgement to each node confirming the node is registered in the dynamic light system 100. In some embodiments, a node may no longer respond to Poll requests for some predefined period of time after receiving the acknowledgement to avoid network congestion. It should be noted that the first time a node is discovered that some of the configuration parameters may need to be updated by the controller 106 to insure that each node is assigned a unique ID (e.g., not shared by an existing node) and has a compatible firmware version. Likewise, the controller 106 may also associate the node with a different group ID based on user input and/or other factors such as node configuration as discussed above. In any such cases, these configuration changes may be performed in the configuration process of act 206 as discussed below. In some cases, the controller 106 may wait a predefined amount of time (e.g., 3 seconds) for all nodes to reply before exiting the discovery process 204.

In an embodiment, a node may visually display its operational status in regard to the dynamic light system 100. For example, the first time a node is turned on the node may emit a red light via its light assembly until network connectivity is confirmed. In this example, the node may then switch from emitting a red color to a yellow, for instance, to signify network connectivity. Such a color change might be used to signify events such as the successful association of a Wi-Fi network if the node is configured with a valid SSID and passphrase. In another example, the node may indicate that a passphrase was invalid, or any other error state of the node, by emitting a particular color, light pattern, or effect such as flashing, pulsing, etc. A user or technician of the dynamic light system 100 may be trained to recognize what the color and/or pattern means within the context of an error and take appropriate corrective action.

Returning to FIG. 2, the method 200 includes the optional execution of a configuration process in act 206 after discovering one or more nodes during the discovery process 204. In one embodiment, the controller 106 may initiate an update of a node's configuration parameters either through receiving user input and/or automatically determining an update should occur (e.g., to uniquely address each node). Virtually any configuration parameter of the node may be updated via the controller 106 including, for example, an IP address to bind to, a port the node should listen on for control packets, the GID the node is associated with, the UID of the node, the USID the node belongs to, the node type, the SSID, the passphrase, etc. In addition, the controller 106 may update the firmware of a node based on determining the node's current firmware is incompatible/out-of-date. FIG. 3 illustrates an example communication sequence occurring between the controller 106 and N nodes 302 during the configuration process 206. As shown, a configuration packet is transmitted to a node (e.g., via unicast messaging), to change a configuration parameter of the node. In some cases the configuration packet includes a plurality of configuration values to update. In other cases, the configuration packet includes a subset of configuration values to update. In any such cases, a node responds back (ConfigReply) to the controller 106 in response to receiving the configuration packet and applying the configuration changes. In some embodiments, the controller 106 may initiate changes to two or more nodes in an asynchronous (e.g., parallel) fashion.

Returning to FIG. 2, a scene control process in act 208 may be executed by the controller 106. In an embodiment, the scene control process 208 is executed based on the controller 106 receiving a scene selection from, for example, user input. In this embodiment, the scene selection corresponds to a predefined virtual environment which will be illuminated in the area of the dynamic light system 100. As discussed above, the predefined virtual environment is comprised of scene control data which includes a set of predefined values that define lighting characteristics, timing, and media content to be rendered. The controller 106, in turn, constructs data packets with payloads comprised of scene instructions that include the predefined values. In an embodiment, the controller 106 may construct a data packet which targets a specific node, or group of nodes, based on the scene data defining restrictions that certain light/projection instructions should be executed by specific nodes which meet the predefined criteria. For example, predefined criteria may include rules (in the form of logic) that light assemblies and/or projection devices of a particular type or location should receive specific scene instructions. In this example, a node may be configured with a type of light assembly that is ideally configured (e.g., has a particular number of color channels and color capability) for certain scene instructions and meet the predefined criteria. As discussed above, scene instructions can comprise virtually any dynamic light pattern, such as a candle flicker, a sun rise, a faulty street light, or perhaps the glow of a neon sign, just to name a few. So, in some cases scene data may be utilized to identify nodes which are capable of illuminating a particular light pattern based on their respective configuration. In some cases, scene instructions are comprised of CIE XYZ tri-stimulus values. It should be appreciated that tri-stimulus values are ideally suited controlling nodes with varying color channel configurations as the CIE XYZ model is result-oriented (insuring a particular color is output) versus channel-specific (controlling the specific mix of each color channel). Stated differently, a node which receives a CIE XYZ value may optimize and reproduce the desired color based on the color gamut of its associated light assembly. Conversely, scene instructions may be explicit as to which color channels should be utilized to produce a particular output. For example, some nodes may be configured with light assemblies having 3, 4, or 10+ color channels. To this end, the scene instructions may be comprised of, for example, RGB or RGBY color values, based on the controller 106 knowing the channel composition of each node. In another example, scene instructions include media content for playback such as still images, movies, and/or accompanying audio tracks that are most appropriately rendered by nodes which include a projection device and/or speakers. In this example, the scene instructions may include not only the media content to playback but a location (e.g., a URI) to a node acting as a content server. So, in some cases, nodes with projecting devices may be “bare-bones” with just enough hardware and resources enabling the ability to stream/download media content from other servers in order to render the media content. In any such examples, the controller 106 encapsulates the scene instructions for the nodes into one or more data packets and transmits the data packets either by unicast, or multicast/broadcast, in order to initiate a scene change. Once a node receives its scene instructions, illumination and/or projection of the scene is immediately initiated by the node, in some embodiments. In some cases, the node responds to scene instructions with an acknowledgement. In an embodiment, the controller 106 may suspend the scene by transmitting an EndScene request to the nodes 108-114. FIG. 3 illustrates an example communication sequence occurring between the controller 106 and N nodes 302 during the scene control process 208. As shown, one or more packets containing scene instructions is sent by the controller 106 to a node, or a group of nodes. In some cases, packets containing scene instructions are sent in parallel (asynchronously) to all nodes. Once received, the receiving node may then transmit an acknowledgement back to the controller 106. In some cases, no further scene control packets may be sent to an acknowledging node once the controller 106 receives an acknowledgement in order to minimize network congestion. As discussed above, and in accordance with an embodiment, the nodes 108-114 continue to illuminate the scene indefinitely. So, although the controller 106 is initially used to select a particular scene (or virtual environment) and command the nodes, the dynamic light system 100 may continue to illuminate a scene even if the controller is no longer associated with the network (e.g., out of range, turned off, suspended, etc.). It should be appreciated that such an arrangement enables a de-centralized dynamic light system which is capable of cohesively commanding any number of nodes (and node configurations therein) in order to recreate a virtual environment through distributed illumination of light patterns (e.g., ambient, dynamic, etc.) and media playback (still imagery, video, and audio playback).

Example System Implementation and Use Case

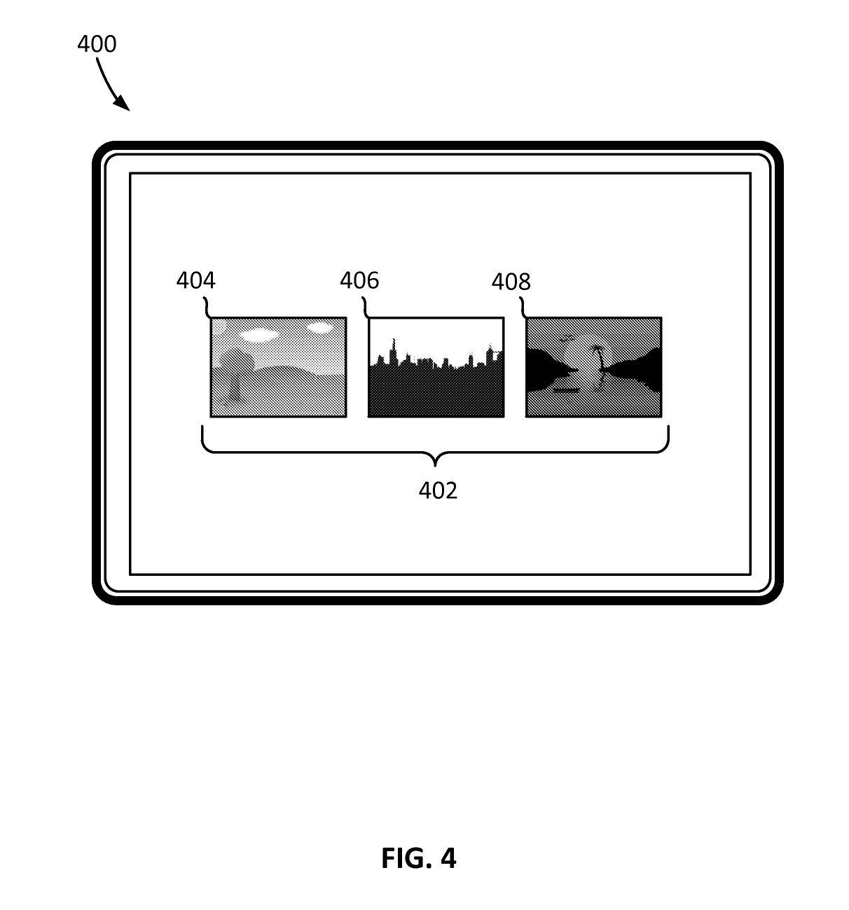

Some aspects and embodiment disclosed herein may be better understood by way of example. Referring now to FIG. 4 with additional reference to FIGS. 1-3, an example controller 400 configured to control a dynamic light system is illustrated in accordance with an embodiment of the present disclosure. As shown, the controller 400 is a tablet computer system and may include aspects and embodiments as discussed above with regard to controller 106 of FIG. 1. Prior to scene selection, the controller 400 may execute the discovery process 204 to determine the presence and configuration of one or more nodes connected to the same network. For instance, the controller 400 may be connected to the wireless access point 102 and have an IP address with a corresponding subnet that is identical to one or more nodes (e.g., an IP address of 192.168.1.X). In this instance, the controller 400 may broadcast a discovery Poll packet (e.g., using UDP) which encapsulates a data structure as outlined in Table A.

TABLE 1

| | | Size | |
|---|---|---|---|
| Field | Index | (Bytes) | Description |
| Header | 0 | 8 | Null-terminated string of 6 |
| | | | characters |
| PacketType | 8 | 2 | Packet Type |
| ProtocolVersion | 10 | 2 | Protocol Version Number |
| IPAddress | 12 | 4 | IPv4 address |
| Port | 16 | 2 | Listening Port |
| Footer | 18 | 4 | Null-terminated EOT string of 4 |
| | | | characters |

As shown in Table A, a Poll packet can include several elements that allow a receiving node to respond during the discovery process 204. For example, a static null-terminated string of characters may be included as a header in the poll packet to allow receivers to identify whether the packet is valid, or perhaps if it was erroneously sent to the listener's port by a process unrelated to the dynamic light system 100. Additional fields such as the PacketType allow a receiver to determine what type of packet has been received. Typically, each node is configured to recognize packet types based on the values of Table B, for example. Although Table B includes a separate packet for light instructions and media instructions, it should be recognized that these scene control packets are generically referred to as a “SceneInstruction” packets as discussed above in regard to FIGS. 2 and 3, and their associated description. Other parameters of the Poll packet allow a node to easily determine compatibility with the message based on the ProtocolVersion field and respond directly back to the controller based on the provided IP Address and Port. An end-of-transmission (EOT) sequence ends the packet. As shown in Table C, a PollReply may contain each configurable parameter of a node that is available to be configured remotely.

TABLE 2

| Name | Value | Type | Source | Destination |
|---|---|---|---|---|
| Poll | 0x1000 | Broadcast | Controller | Node |
| PollReply | 0x1100 | Unicast | Node | Controller |
| PollReplyAck | 0x1200 | Unicast | Controller | Node |
| Config | 0x2000 | Unicast | Controller | Node |
| LightInstruction | 0x3000 | Unicast/Broadcast | Controller | Node |
| MediaInstruction | 0x4000 | Unicast/Broadcast | Controller | Node |

TABLE 3

| | | Size | |
|---|---|---|---|
| Field | Index | (Bytes) | Description |
| Header | 0 | 8 | Null-terminated string of 6 |
| | | | characters |
| PacketType | 8 | 2 | Packet Type |
| ProtocolVersion | 10 | 2 | Protocol Version Number |
| IPAddress | 12 | 4 | IPv4 address |
| Port | 16 | 2 | Listening Port |
| GroupID | 18 | 1 | Associated Group ID |
| NodeID | 19 | 1 | Unique Node ID |
| NodeType | 20 | 2 | Type of Node |
| SystemID | 22 | 8 | Dynamic Light System ID |
| FirmwareVersion | 30 | 8 | Firmware Version of Node |
| Footer | 38 | 4 | Null-terminated EOT string of 4 |
| | | | characters |

As shown in Table C, the PollReply packet may contain fields which are similar to those included in the Poll packet. The controller 400 can receive and inspect the contents of each PollReply packet to determine the presence of nodes on the network and their corresponding configuration parameters. These parameters can include, for example, a node type indicator, a UID, a GID, a USID, and the current version of firmware. Also, parameters such as the node's current IP address, listening port, and protocol version are provided to the controller 106 for convenience during subsequent processes and to determine that the node is compatible with the protocol version implemented by the controller 106. In some cases, more than one dynamic light system may utilize the same network and, for this reason, nodes belonging to a particular dynamic light system may be easily identified by a SUID. As discussed above, the first time a node is discovered some of the parameters may need to be updated by the controller 400 to insure that each node is assigned a unique identifier (UID) and has a compatible firmware version. Likewise, the controller 400 may also associate the node with a different GID based on user input and/or factors such as physical node location, light output capabilities, projection capabilities, etc.

Returning to the example case, once nodes have responded and their associated configuration parameters have been received and stored, the controller 400 may execute the configuration process 206. As discussed above with reference to FIGS. 1-2, configuration of nodes may be initiated by user input or perhaps automatically when a node is discovered. In any case, the controller 400 may send a configuration packet which is nearly identical to the data structure outlined in Table C. However, additional fields may also be included, such as a delay interval which the node might use prior to sending subsequent responses to the controller 400 in order to reduce network congestion. In addition, a field may be included which indicates to the node which field has changed by the controller 400 and should be updated accordingly. Such a field may be a bit-field which sets a flag allowing a node to quickly determine which configuration parameter was updated by the controller 400.

After the discovery process 204, and after optionally executing configuration process 206, the scene control process 208 may be executed. The controller 400 is depicted with an “app” running which includes a custom user interface which renders one or more virtual environment representation tiles 402. In an embodiment, the virtual representation and corresponding scene data may have been downloaded from, for instance, a web service, an “app” store, or external storage device such as a USB stick. As shown, the virtual environment representation tiles 402 include a day light scene 404, a city at night scene 406, and a sunset scene 408. The controller 400 may then receive user input (e.g., by way of an appropriate placed tap on the touchscreen of controller 400, or a mouse-click for non-touchscreen configurations) which indicates a particular virtual environment representation has been selected. As discussed above, the scene data may then be parsed by the controller 400 and encapsulated as scene instructions in one or more packets. One example packet including scene instructions for a light assembly node is outlined in Table D.

TABLE 4

| | | Size | |
|---|---|---|---|
| Field | Index | (Bytes) | Description |
| Header | 0 | 8 | Null-terminated string of 6 |
| | | | characters |
| PacketType | 8 | 2 | Packet Type |
| ProtocolVersion | 10 | 2 | Protocol Version Number |
| IPAddress | 12 | 4 | IPv4 address |
| Port | 16 | 2 | Listening Port |
| GroupID | 18 | 1 | Associated Group ID |
| NodeID | 19 | 1 | Unique Node ID |
| SystemID | 20 | 8 | Dynamic Light System ID |
| PacketSequence | 20 | 2 | Type of Node |
| SystemFlag | 22 | 1 | Exclusive to one system, or |
| | | | broadcast |
| InstructionType | 23 | 1 | Instruction Type (CIE XYZ, |
| | | | RGB, etc.) |
| InstructionCnt | 24 | 1 | Size of N-Channel Sequence |
| InstructionPayload | 25 | N | Channel values, timings, etc. |
| Footer | 25 + N | 4 | Null-terminated EOT string of 4 |
| | | | characters |

As shown in Table D, a SceneInstruction packet includes similar fields to that of the Poll and PollReply packets. To this end, a single SceneInstruction packet can be transmitted to a node, or a group of nodes, based on the various fields within the packet. Additional fields may appear for added convenience and functionality. For example, Table D also includes a SystemFlag which allows for the synchronization of multiple dynamic light systems. For example, consider that a particular area includes several distinct dynamic light systems and their associated nodes. Further, consider that each distinct dynamic light system utilizes the same network. By setting the SystemFlag (e.g., to 0x00), a single SceneInstruction packet can be utilized by all of the dynamic light systems to synchronize their illumination output, and thus, illuminate the same virtual environment. Also within a given SceneInstruction packet can be a definition of instruction type (e.g., CIE XYZ, RGB, RGBY, etc) and an array of the instructions within the defined InstructionPayload field. As shown, the array of instructions may be dynamically sized and only limited by, for instance, the MTU of the network. In one embodiment, the array of instructions is a sequence of instructions which might be indexed by channels (e.g., when providing RGB/RGBY values) or a list of CIE XYZ values. In addition, the instructions may include a leading or trailing byte which indicates a time interval (e.g., in milliseconds). In one specific example, consider a four channel light assembly having a RGBY color channel configuration. In this example, a binary sequence of 0xFF 0x00 0x00 0x00 0x03 0xE8 would result in an output of the color red for 1000 ms. In this example binary array, the time interval is the last two bytes (0x03E8) with bytes 1-4 corresponding to the respective color channel red (0xFF), green (0x00), blue (0x00), and yellow (set to decimal 0). So, any number of these binary sequences may be within the InstructionPayload field, and when executed in sequence, result in a particular light pattern being output based on the time intervals. Likewise, consider another example with the same four channel light assembly but instead in the context of a CIE XYZ SceneInstruction packet. In this example, the InstructionPayload field may comprise an array CIE XYZ values and a time interval. For instance, the first four bytes may be a float value and correspond to the X tristimulus value, the second four bytes may be a float value and correspond to the Y tristimulus value, and the next four bytes may be a float value and correspond to the Z tristimulus value with the final byte being a time interval. So, an array of the CIE XYZ values, when executed in sequence, can also result in a particular light pattern being output. As discussed above, CIE XYZ values are particularly well suited for a dynamic light system with N nodes as the values can be interpreted by the node to output a particular color regardless of each node's particular color channel configuration.

In some example cases one or more nodes with a projection device may be present. In these cases, a SceneInstruction packet might define a payload defining a media file, or a static scene ID value in order to render a particular image, movie, etc. In one case, the media file might comprise a path to retrieve the media file for playback, such as from a node acting as a content server. In another case, the media file is already present on the node and may be referenced by file name, full path, or predefined scene ID. In still other cases, any number of media files may be identified for playback with predefined time intervals between. In these cases, the time interval may define how long each media file should be rendered prior to rendering the next media file within the scene instructions.

So, it should be appreciated that a SceneInstruction packet might encapsulate all of the instructions necessary for a node to continue illumination (and media rendering), regardless of whether a controller, such as the controller 400, remains communicatively coupled to the network. However, the controller 400 may also continuously control scenes by transmitting SceneInstruction packets as needed.

System

FIG. 5 illustrates a computing system 500 configured to execute processes for discovering, managing, and controlling a plurality of nodes within a dynamic light system in accordance with techniques and aspects provided in the present disclosure. As can be seen, the computing system 500 houses a processor 502, a data storage device 504, a memory 506, a network interface 508, an IO interface 510 and an interconnection element 512. To execute at least some aspects provided herein, the processor 502 receives and performs a series of instructions that result in the execution of routines and manipulation of data. In some cases, the processor is at least two processors. In some such cases, the processor may be multiple processors or a processor with a varying number of processing cores. The memory 506 may be random access (RAM) and configured to store sequences of instructions and other data used during the operation of the computing system 500. To this end, the memory 506 may be a combination of volatile and non-volatile memory such as dynamic random access memory (DRAM), static memory (SRAM), or flash memory, etc. The network interface 508 may be any interface device capable of network-based communication. Some examples of such a network interface include an Ethernet, Bluetooth, Fibre Channel, Wi-Fi and RS-232 (Serial). The data storage device 504 includes any computer readable and writable non-transitory storage medium. The storage medium may have a sequence of instructions stored thereon that define a computer program that may be executed by the processor 502. In addition, the storage medium may generally store data in contiguous and non-contiguous data structures within a file system of the storage device 504. The storage medium may be an optical disk, flash memory, a solid state drive (SSD), etc. During operation, the computing system 500 may cause data in the storage device 504 to be moved to a memory device, such as the memory 506, allowing for faster access. The IO interface 510 may be any number of components capable of data input and and/or output. Such components may include, for example, a display device, a touchscreen device, a mouse, a keyboard, a microphone, external device (USB, fire wire, etc.) and speakers. The interconnection element 512 may comprise any communication channel/bus between components of the computing system 500 and operate in conformance with standard bus technologies such as USB, IDE, SCSI, PCI, etc.

Although the computing system 500 is shown in one particular configuration, aspects and embodiments may be executed by computing systems with other configurations. As discussed above, some embodiments include a controller 106 comprising a tablet device. Thus, numerous other computer configurations and operating systems are within the scope of this disclosure. For example, the computing system 500 may be a propriety computing device with a mobile operating system (e.g., an Android device). In other examples, the computing system 500 may implement a Windows®, or Mac OS® operating system. Many other operating systems may be used, and examples are not limited to any particular operating system.

Numerous variations and configurations will be apparent in light of this disclosure. For example, one embodiment of the present invention provides a computing device. The device includes a memory, a display, a network interface device configured to couple with a wireless network, and a processor coupled to the memory, the display, and the network interface, and configured to execute a scene control process configured to receive scene control data corresponding to a target virtual environment for presentation by a lighting system, the scene control process further configured to determine a sequence of scene instructions based on the scene control data and send the sequence of scene instructions to one or more lighting system nodes communicatively coupled to the network. In some cases, the processor is further configured to execute a discovery process configured to discover the one or more nodes, wherein the discovery process is further configured to store configuration parameters received from the one or more discovered nodes, and wherein the configuration parameters comprise illumination or projection capabilities of the one or more discovered nodes, and wherein the configuration parameters further include at least one of a physical position identifier, a color channel configuration, a group identifier, a unique node identifier, a node type, a light system identifier and a firmware version. In some cases, the scene control process is configured to download the scene control data corresponding to the virtual environment from a web service accessible via the network. In some cases, the sequence of scene instructions comprises color stimulus values and time intervals. In one such case, the color stimulus values include at least one of a red green blue (RGB) value, a red green blue yellow (RGBY) value, and a tristimulus value. In another such case, the color stimulus values and time intervals comprise a predefined dynamic light pattern associated with the target virtual environment. In one such case, the predefined dynamic light pattern is theme-based. In some cases, the sequence of instructions includes an identifier of a media file.

Another embodiment provides a method for dynamically illuminating an area. The method includes: sending a discovery request to a plurality of nodes on a wireless network, wherein at least one node includes a light assembly configured to illuminate an area external to the node; receiving, in response to the discovery request, configuration parameters corresponding to the at least one node; receiving scene control data corresponding to a target virtual environment for presentation by at least in part the light assembly; and sending a sequence of instructions to the at least one node based on the scene control data and the configuration parameters. In some cases, sending the discovery request includes broadcasting a user datagram packet (UDP). In some cases, the received configuration parameters include at least one of a physical location identifier, a color channel configuration, a group identifier, a unique node identifier, a node type, a light system identifier and a firmware version. In some cases, the target virtual environment is presentable using lights and media playback. In some cases, receiving scene control data corresponding to the target virtual environment further includes: displaying a plurality of virtual environments representations via a display; and determining the target virtual environment based on user selection of one of the plurality of virtual environment representations. In some cases, the sequence of instructions comprises color stimulus values and time intervals, wherein the color stimulus values include at least one of a red green blue (RGB) value, a red green blue yellow (RGBY) value and a tristimulus value. In one such case, the color stimulus values and time intervals comprise a predefined dynamic light pattern associated with the selected virtual environment.

Another embodiment provides a light assembly. The light assembly includes a multi-channel light source configured to illuminate an area external to the light assembly, a network interface configured to couple with a wireless network, and a processor coupled to the multi-channel light source and the network interface. The processor is programmed or otherwise configured to: receive a first scene instruction via the network, the first scene instruction including a plurality of color stimulus values and corresponding time intervals for outputting each color stimulus value; and control the multi-channel light source to output each color stimulus value of the plurality of color stimulus values sequentially based on an order of instructions within the first scene instruction and the corresponding time intervals. In some cases, at least one of: the plurality of color stimulus values include at least one tristimulus value; the light assembly is configured to optimize the output of the tristimulus value based on a color gamut of the multi-channel light source; and the plurality of color stimulus values are indexed by color channels. In some cases, the first scene instruction further identifies a media file, and the processor is further configured to control a media playback device to present the media file. In some cases, the processor is further configured to change an output color of the multi-channel light source based on network connectivity. In some cases, the processor is further configured to receive an updated configuration parameter via the network and apply the updated configuration parameter.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A computing device, comprising:
a memory;
a display;
a network interface device configured to couple with a wireless network;
a processor coupled to the memory, the display, and the network interface, and configured to execute a scene control process configured to receive scene control data corresponding to a target virtual environment for presentation by a lighting system, the scene control process further configured to determine a sequence of scene instructions based on the scene control data and send the sequence of scene instructions to one or more lighting system nodes communicatively coupled to the network.

2. The computing device of claim 1, wherein the processor is further configured to execute a discovery process configured to discover the one or more nodes, wherein the discovery process is further configured to store configuration parameters received from the one or more discovered nodes, and wherein the configuration parameters comprise illumination or projection capabilities of the one or more discovered nodes, and wherein the configuration parameters further include at least one of a physical position identifier, a color channel configuration, a group identifier, a unique node identifier, a node type, a light system identifier and a firmware version.

3. The computing device of claim 1, wherein the scene control process is configured to download the scene control data corresponding to the virtual environment from a web service accessible via the network.

4. The computing device of claim 1, wherein the sequence of scene instructions comprises color stimulus values and time intervals.

5. The computing device of claim 4, wherein the color stimulus values include at least one of a red green blue (RGB) value, a red green blue yellow (RGBY) value, and a tristimulus value.

6. The computing device of claim 4, wherein the color stimulus values and time intervals comprise a predefined dynamic light pattern associated with the target virtual environment.

7. The computing device of claim 6, wherein the predefined dynamic light pattern is theme-based.

8. The computing device of claim 1, wherein the sequence of instructions includes an identifier of a media file.

9. A method for dynamically illuminating an area, the method comprising:
sending a discovery request to a plurality of nodes on a wireless network, wherein at least one node includes a light assembly configured to illuminate an area external to the node;
receiving, in response to the discovery request, configuration parameters corresponding to the at least one node;
receiving scene control data corresponding to a target virtual environment for presentation by at least in part the light assembly; and
sending a sequence of instructions to the at least one node based on the scene control data and the configuration parameters.

10. The method of claim 9, wherein sending the discovery request includes broadcasting a user datagram packet (UDP).

11. The method of claim 9, wherein the received configuration parameters include at least one of a physical location identifier, a color channel configuration, a group identifier, a unique node identifier, a node type, a light system identifier and a firmware version.

12. The method of claim 9, wherein the target virtual environment is presentable using lights and media playback.

13. The method of claim 9, wherein receiving scene control data corresponding to the target virtual environment further includes:
displaying a plurality of virtual environments representations via a display; and
determining the target virtual environment based on user selection of one of the plurality of virtual environment representations.

14. The method of claim 9, wherein the sequence of instructions comprises color stimulus values and time intervals, wherein the color stimulus values include at least one of a red green blue (RGB) value, a red green blue yellow (RGBY) value and a tristimulus value.

15. The method of claim 14, wherein the color stimulus values and time intervals comprise a predefined dynamic light pattern associated with the selected virtual environment.

16. A light assembly, comprising:
a multi-channel light source configured to illuminate an area external to the light assembly;
a network interface coupled to a wireless network; and
a processor coupled to the multi-channel light source and the network interface, and configured to:
receive a first scene instruction via the network, the first scene instruction including a plurality of color stimulus values and corresponding time intervals for outputting each color stimulus value; and
control the multi-channel light source to output each color stimulus value of the plurality of color stimulus values sequentially based on an order of instructions within the first scene instruction and the corresponding time intervals.

17. The light assembly of claim 16, wherein at least one of:
the plurality of color stimulus values include at least one tristimulus value;
the light assembly is configured to optimize the output of the tristimulus value based on a color gamut of the multi-channel light source; and
the plurality of color stimulus values are indexed by color channels.

18. The light assembly of claim 16, wherein the first scene instruction further identifies a media file, and the processor is further configured to control a media playback device to present the media file.

19. The light assembly of claim 16, wherein the processor is further configured to change an output color of the multi-channel light source based on network connectivity.

20. The light assembly of claim 16, wherein the processor is further configured to receive an updated configuration parameter via the network and apply the updated configuration parameter.
